(19) United States
(12) Patent Application Publication
(10) Pub. No.: US 2026/0367721 A1
(43) Pub. Date: Nov. 19, 2026

(54) METHOD AND APPARATUS FOR REDUCING UNWANTED MOUSE CURSOR MOVEMENT DURING LIFTING AND LANDING

(71) Applicant: PixArt Imaging Inc., Hsin-Chu City (TW)

(72) Inventors: Willie SONG, Penang (MY); Zi Hao TAN, Penang (MY)

(73) Assignee: PixArt Imaging Inc., Hsin-Chu City (TW)

(21) Appl. No.: 19/206,093

(22) Filed: May 13, 2025

(51) Int. Cl. G06F 3/038; G06F 3/03; G06F 3/033; G06F 3/0346; G06F 3/0354

(52) U.S. Cl. CPC G06F 3/0383; G06F 3/0304; G06F 3/033; G06F 3/0346; G06F 3/03543

(57) ABSTRACT

An optical mouse is disclosed which can perform DPI downshift when the optical mouse enters a lifted state and perform gradual DPI increase when the optical mouse enters an unlifted state. The optical mouse includes: a sensor which has a dots per inch (DPI) setting/configuration and reports movement when the optical mouse moves on a surface; and a micro-processing unit (MCU) which is configured to determine a lifted state and an unlifted state of the optical mouse according to a sensor position and a lift-off distance, wherein the MCU lowers the DPI to be a percentage of the original DPI configuration when the optical mouse enters a lifted state, and the MCU increases the lowered DPI in increments to reach the original DPI configuration when the optical mouse enters an unlifted state from the lifted state.

### BACKGROUND OF THE INVENTION

### 1. Field of the Invention

This invention relates to mouse cursor movement, and more particularly, to a method and apparatus for reducing unwanted mouse cursor movement during lifting and landing.

### 2. Description of the Prior Art

Dots per inch (DPI) is a parameter indicating how small a movement can be perceived by the sensor of an optical mouse. A lower DPI means the accuracy of the mouse is also lower, whereas a higher DPI means the mouse will report more for the same amount of movement. By adjusting the DPI, the amount of movement reported by a mouse can thereby be adjusted.

Lift-off Distance (LoD) refers to the height at which a mouse Sensor stops tracking. Competitive gamers need to re-centre their mouse a lot, which requires lifting and then lowering the mouse. In addition, certain actions such as performing a ‘flick’ may require the mouse to be lifted. Setting the LoD to a low value can avoid unintended cursor movement when the mouse is being lifted and lowered, but this may increase tracking errors. High LOD can allow a user to keep aiming at elevation, but more unintended motion in the Y axis will be reported.

Refer to FIG. 1, which illustrates the motion of a mouse 100 on a surface 120. As shown in the diagram, lowering and raising the mouse 100 occurs in a parabola motion. A dotted line representing the LoD is drawn above the surface 120, wherein when the mouse 100 is above the dotted line, the mouse 100 is regarded as being in a lifted state. The region between the dotted line and the surface 120 is a region wherein a sensor of the mouse 100 will still report any Y (vertical) motion, even though this motion may not be intentional.

As a DPI setting corresponds to the amount of movement reported by the mouse, unintended Y motion will become particularly evident when the mouse has a high DPI setting, which is often used during high precision applications such as gaming. This unintended Y motion will be seen by the user, which detracts from the overall user experience.

### SUMMARY OF THE INVENTION

In accordance with an exemplary embodiment of the present invention, a mouse is disclosed which can perform DPI downshift when the mouse enters a lifted state, and perform gradual DPI upshift when the mouse enters an unlifted state. The mouse comprises: a sensor which has a DPI setting/configuration and reports movement when the mouse moves on a surface; and a micro-processing unit (MCU) which is configured to determine a lifted state and an unlifted state of the mouse according to a sensor position and a lift-off distance, wherein the MCU lowers the DPI to be a percentage of the original DPI configuration when the mouse enters a lifted state, and the MCU increases the lowered DPI in increments to reach the original DPI configuration when the mouse enters an unlifted state from the lifted state.

In accordance with another exemplary embodiment of the present invention, a method for performing DPI downshift of a mouse when the mouse enters a lifted state and for performing gradual DPI upshift when the mouse enters an unlifted state comprises: setting a lift-off distance for the mouse; when it is determined that the mouse has exceeded the lift-off distance and is in a lifted state, lowering a dots per inch (DPI) setting of the mouse to be a percentage of an original DPI configuration; and when it is determined that the mouse has gone below the lift-off distance and has entered an unlifted state from the lifted state, increasing the lowered DPI in increments to reach the original DPI configuration.

The original DPI configuration is 100% of the DPI setting, and the lowered DPI may be 10% of the original DPI configuration. The MCU increases the lowered DPI in increments wherein the size of each increment may be equal or may be different. In addition, the time for each increment may be equal or may be different. The DPI downshift is downshift for motion in a Y axis or for motion in both the Y and X axes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a mouse being lifted and landed on a surface according to the related art.

FIG. 2 is a diagram illustrating adjustment of DPI settings according to an exemplary embodiment of the present invention.

FIG. 3A is a diagram illustrating motion of a mouse without DPI downshift.

FIG. 3B is a diagram illustrating motion of a mouse with DPI downshift.

FIG. 4A illustrates a mouse according to a first embodiment of the present invention.

FIG. 4B illustrates a mouse according to a second embodiment of the present invention.

### DETAILED DESCRIPTION

As detailed above, unintended motion may be reported when the mouse is lifted but is not determined to be in a lifted state according to the lift-off distance (Lod) setting of the mouse.

The present invention therefore downshifts the DPI setting for the Y axis to a percentage of the original DPI configuration when it is determined that the mouse has entered a lifted state. When the mouse returns to an unlifted state, the Y DPI configuration is gradually increased to the original DPI setting. In addition, this DPI downshift can also be performed for motion in the X axis.

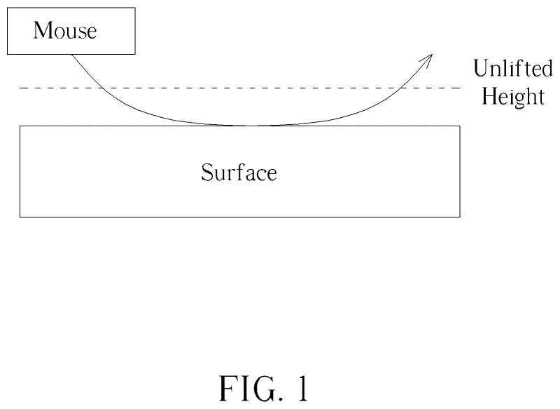

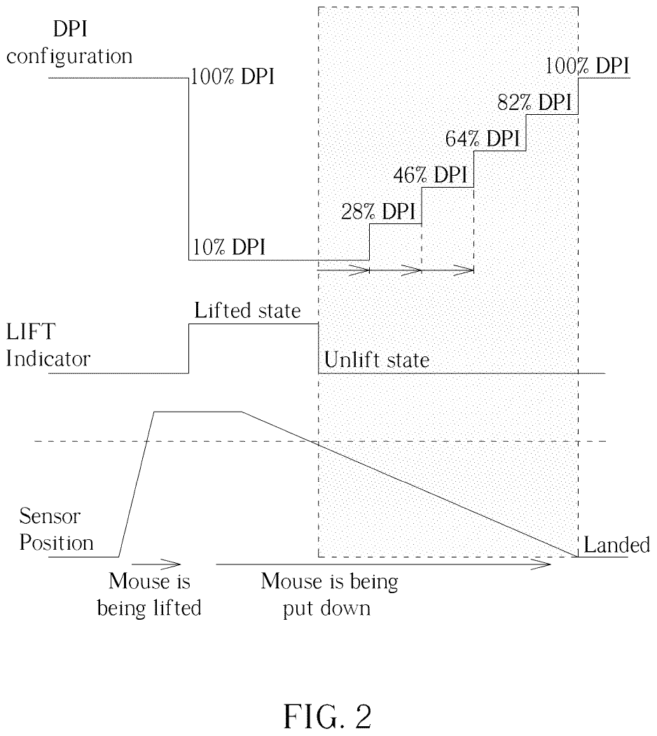

Refer to FIG. 2 which illustrates a number of parameters for an optical mouse such as the mouse illustrated in FIG. 1. The top parameter is DPI configuration, which illustrates the DPI setting of the mouse. The middle parameter is LIFT indicator, which is a binary signal that is low when the mouse is determined to be in an unlifted state and goes high when the mouse is determined to be in a lifted state. The bottom parameter is sensor position, which tracks the position of the sensor with respect to the LoD of the mouse, wherein when the sensor position is above the LoD, the LIFT indicator goes high, and when the sensor position is below the LoD, the LIFT indicator goes low.

Initially, the DPI configuration of the mouse operates at 100%. At a certain point, the mouse is raised as shown by the sensor position, wherein when the sensor position goes above the LoD (indicated by the dotted line) the LIFT indicator goes high. At this point, the DPI configuration is downshifted to be 10% of the initial DPI configuration. The mouse remains lifted for a short amount of time and is then lowered. When the sensor position goes below the LoD, the LIFT indicator goes low, indicating the mouse has gone back to an unlifted state. The shaded region indicates the region for which unintended Y motion would be reported as the mouse has not landed on the surface but is below the LoD.

In order to prevent this, the DPI is increased gradually from the 10% setting in increments. If the DPI were immediately increased to be 100% (the initial DPI configuration) as soon as the mouse goes below the LoD, this sudden increase would be seen as a noticeable ‘jump’ in cursor motion of the mouse. The incremental change as taught by the present invention, however, will feel more natural to a user.

In the example shown in FIG. 2, the DPI is increased in five increments, wherein each increment step involves an 18% increase in the DPI settings, such that the increase goes from 10%→28%→46%→64%→82%→100%. Further, the time for each increment step is equal. The examples illustrated in FIG. 2 are merely for illustrative purposes, however; the number of increment steps, the size of the increment steps and the time for each increment step can all be adjusted according to system preferences or user requirements. In addition, the amount of DPI downshift when the mouse enters a lifted state can also be adjusted, and 10% is merely given as an example.

If the DPI percentage increase per increment step is higher than the amount illustrated in FIG. 2, the number of increment steps will be fewer than five; similarly, if the percentage increase is lower per increment step than the amount illustrated in FIG. 2, the number of increment steps will be greater than five. In addition, the time for each increment step can be variable. These settings may be automatic, i.e. set by the mouse, or they may be selected by a user.

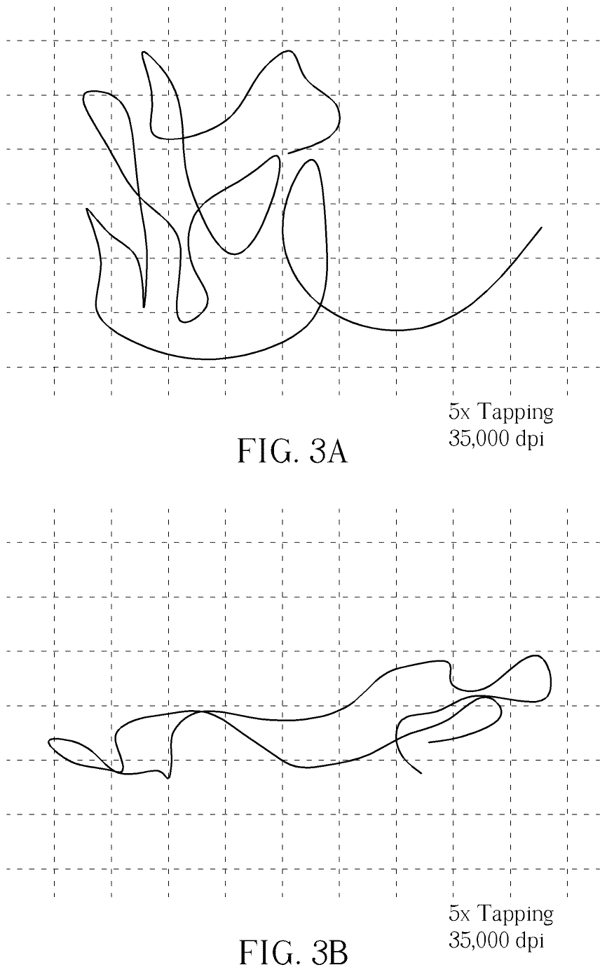

The Y DPI downshift as described above results in significantly reduced Y motion as perceived by a user. Refer to FIG. 3A, which illustrates motion of a cursor without the DPI downshift upon lifting and incremental increase upon landing. As seen in the diagram, there is a lot of unintended Y motion which is clearly observable.

Refer to FIG. 3B, which illustrates motion of a cursor with the DPI downshift upon lifting and incremental increase upon landing as taught by the present invention. The Y motion is much less noticeable than in the example shown in FIG. 3A.

Note that the same technique can be applied to X motion; specifically, side to side motion. In most gaming or high precision applications, the motion tends to be more backwards and forwards rather than side to side. Therefore, by limiting DPI when X motion is detected, unintended motion in two axes can be prevented.

As detailed above, the adjustment in DPI can be automatically set by a system or can be set according to user requirements. As the invention requires dynamic adjustment of the DPI according to a sensor position, the mouse must be configured to receive signals which adjust parameters of the sensor. This function can be performed by a micro-processing unit or a micro-controller unit.

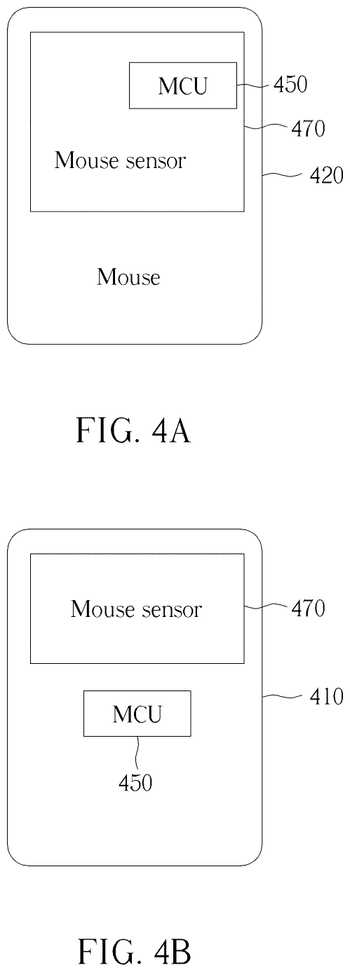

Refer to FIG. 4A which illustrates a mouse 420 having a mouse sensor 470 and a micro-controller unit (MCU) 450 which is internal to the sensor 470. The sensor will determine a position of the mouse with respect to the LoD and send this information to the MCU, which can then send information for adjusting the DPI. Note that this diagram is one example of internal components of a mouse. Refer to FIG. 4B which illustrates a mouse 410 having an MCU 450 which is external to the sensor 470. In the example shown in FIG. 4B, the MCU 450 receives signals from the sensor 470 indicating a position of the mouse with respect to the LoD, and sends signals to the mouse sensor 470 instructing the sensor 470 to adjust the DPI configuration as taught in FIG. 2. Note that the above examples are two illustrations of the present invention, and other modifications to an optical mouse may be made, as long as the mouse is able to achieve the DPI adjustment as taught herein.

According to the method and device of the present invention, once it is determined that a mouse is in a lifted state, the DPI configuration can be downshifted to be a small percentage of the initial DPI setting, and when it is determined that the mouse has gone below a lift-off distance, this downshifted DPI is then gradually increased in increments such that the DPI goes back to the initial setting once the mouse has contacted a surface. This technique can reduce unwanted sensor motion, thereby improving a user experience.

Those skilled in the art will readily observe that numerous modifications and alterations of the device and method may be made while retaining the teachings of the invention. Accordingly, the above disclosure should be construed as limited only by the metes and bounds of the appended claims.

1: An optical mouse, which can perform dots per inch (DPI) downshift when the optical mouse enters a lifted state and perform gradual DPI increase when the optical mouse enters an unlifted state, the mouse comprising:
a sensor which has a DPI setting/configuration and reports movement when the optical mouse moves on a surface; and
a micro-processing unit (MCU) which is configured to determine a lifted state and an unlifted state of the optical mouse according to a sensor position and a lift-off distance, the MCU lowers the DPI to be a percentage of the original DPI configuration when the optical mouse enters a lifted state, and when the optical mouse enters an unlifted state from the lifted state and before the optical mouse is landed on the surface, the MCU increases the lowered DPI in increments to reach the original DPI configuration.

2: The optical mouse of claim 1, wherein the original DPI configuration is 100% of the DPI setting, and the lowered DPI is 10% of the original DPI configuration.

3: The optical mouse of claim 1, wherein the MCU increases the lowered DPI in increments wherein the size of each increment is equal.

4: The optical mouse of claim 1, wherein the MCU increases the lowered DPI in increments wherein the size of each increment is different.

5: The optical mouse of claim 1, wherein the MCU increases the lowered DPI in increments wherein the time for each increment is equal.

6: The optical mouse of claim 1, wherein the MCU increases the lowered DPI in increments wherein the time for each increment is different.

7: The optical mouse of claim 1, wherein the DPI downshift is downshift for motion in a Y axis.

8: The optical mouse of claim 7, wherein the DPI downshift further comprises downshift for motion in an X axis.

9: The optical mouse of claim 1, wherein the MCU is external to the sensor.

10: The optical mouse of claim 1, wherein the MCU is internal to the sensor.

11: A method for performing dots per inch (DPI) downshift of an optical mouse when the optical mouse enters a lifted state and for performing gradual DPI increase when the optical mouse enters an unlifted state, the method comprising:
setting a lift-off distance for the mouse;
when it is determined that the optical mouse has exceeded the lift-off distance and is a lifted state, lowering a dots per inch (DPI) setting of the optical mouse to be a percentage of an original DPI configuration; and
when it is determined that the optical mouse has gone below the lift-off distance and has entered an unlifted state from the lifted state and before the optical mouse is landed on the surface, increasing the lowered DPI in increments to reach the original DPI configuration.

12: The method of claim 11, wherein the original DPI configuration is 100% of the DPI setting, and the lowered DPI is 10% of the original DPI configuration.

13: The method of claim 11, wherein the step of increasing the lowered DPI in increments comprises increasing the lowered DPI in increments of equal size.

14: The method of claim 11, wherein the step of increasing the lowered DPI in increments comprises increasing the lowered DPI in increments of different size.

15: The method of claim 11, wherein the step of increasing the lowered DPI in increments comprises increasing the lowered DPI in increments of equal time.

16: The method of claim 11, wherein the step of increasing the lowered DPI in increments comprises increasing the lowered DPI in increments of different time.

17: The method of claim 11, wherein the DPI downshift is downshift for motion in a Y axis.

18: The method of claim 17, wherein the DPI downshift further comprises downshift for motion in an X axis.
